(19) United States
(12) Patent Application Publication
(10) Pub. No.: US 2012/0312544 A1
(43) Pub. Date: Dec. 13, 2012

(54) RISER SYSTEM

(76) Inventors: Charles Tavner, Chichester (GB); Martin Jones, Chichester (GB)

(21) Appl. No.: 13/158,100

(22) Filed: Jun. 10, 2011

(51) Int. Cl. E21B 17/01; B23P 11/00

(52) U.S. Cl. 166/367; 29/428

(57) ABSTRACT

A riser system configured to be secured between a surface vessel and a subsea location comprises a primary conduit and an auxiliary conduit extending adjacent the primary conduit, wherein the primary and auxiliary conduits are connected together at an axial location along the riser system via a connecting portion. The auxiliary conduit comprises a composite material formed of at least a matrix and one or more reinforcing elements embedded within the matrix,

### FIELD OF THE INVENTION

The present invention relates to a riser system, and in particular to a riser system comprising a primary riser conduit and one or more auxiliary conduits extending adjacent the riser conduit.

### BACKGROUND TO THE INVENTION

In the oil and gas industry subsea wellbores are drilled from surface vessels, such as drill ships, semi-submersible rigs, jack-up rigs and the like, as is well known in the art. Typically, a drilling riser is provided which extends between the wellhead and a surface vessel to provide a contained passage for equipment and fluids. To this extent the drilling riser includes a large bore riser pipe which accommodates the drilling equipment and certain fluids, such as drilling fluids and wellbore fluids, and a number of auxiliary conduits which extend alongside the large bore riser pipe and provide communication of control fluids, well kill fluids, hydraulic power fluid and the like. Such auxiliary lines may terminate at the wellhead, for example at a Blow Out Preventer (BOP) or the like.

The drilling riser is typically formed from a number of individual sections or joints which are secured together in end-to-end relation. Each individual section includes the required auxiliary lines arranged around a length of riser pipe, wherein the ends of the riser pipe and auxiliary lines are terminated at opposing flange connectors. During deployment, the individual sections are secured together via the flange connectors. This arrangement permits the riser pipes and auxiliary lines to be connected and sealed together at a single location to speed up the deployment process.

Known drilling risers are of a metallic construction, typically formed from steel. However, it has been proposed in the art, for example from WO 2010/129191 to provide auxiliary lines composed of aluminium.

During use a drilling riser will be subject to various forces. For example, the drilling riser may be subject to bending loads, for example due to deviation of the drilling vessel relative to the wellhead. Such bending may result in the auxiliary lines being subject to different levels of strain. For example, an auxiliary line on one side of the riser pipe may be subject to tension during bending of the riser, whereas an auxiliary line on an opposing side may be subject to compression. Excessive bending may result in tensile forces exceeding yield limits, and compressive forces causing buckling within the effected auxiliary line. Additionally, these significant differential strains may expose the flange connectors to adverse load conditions. It has been proposed in the art to address such issues by incorporating compliance into the auxiliary lines, for example by use of sliding seal arrangements. However, sliding seals are recognised as a source of reliability problems.

Furthermore, the drilling riser must be capable of supporting very large tensile forces, primarily applied by its own weight. As the industry moves to deeper waters such global tension requirements are becoming significant. Also, deeper environments place the drilling riser under increasing hoop forces due to large hydrostatic pressures. To accommodate the applied tensile and hoop forces the riser pipe sections must be of very thick wall construction, increasing the weight of the system. System weight will also increase in greater water depths due to the use of longer riser pipe and auxiliary lines. In some situations the design requirements of the riser may result in a system having a weight which exceeds the operational limits of conventional drilling vessels.

### SUMMARY OF THE INVENTION

According to a first aspect of the present invention there is provided a riser system configured to be secured between a surface vessel and a subsea location, said system comprising:

a primary conduit; and

an auxiliary conduit extending adjacent the primary conduit and comprising a composite material formed of at least a matrix and one or more reinforcing elements embedded within the matrix,

wherein the primary and auxiliary conduits are connected together at an axial location along the riser system via a connecting portion.

The riser system may comprise or define a drilling riser system. The primary conduit may be configured to accommodate drilling equipment and certain fluids, such as drilling fluids. The auxiliary conduit may be configured to accommodate fluid communication of certain fluids, such as control fluids, well kill fluids or the like between the surface vessel and subsea location.

Both the primary and secondary conduits may be secured relative to a surface vessel.

The riser system may be configured to be secured to a subsea wellhead, for example to a Blow Out Preventer (BOP)

As the auxiliary conduit is secured relative to the primary conduit at the connecting portion, deflection or deformation of the primary conduit may result in load transference to the auxiliary conduit across the connecting portion which may cause deflection or deformation of the auxiliary conduit. However, forming the auxiliary conduit from a composite material may permit increased levels of strain to be accommodated such that said auxiliary conduit may be suitably compliant during such periods of deformation, preventing or minimising failure, such as tensile failure, buckling or the like. Thus, additional measures for accommodating deformations in the auxiliary conduits of known riser systems, such as sliding seal assemblies, may be eliminated.

The composite material may be configured to withstand or permit axial and/or bending strains of up to 6%, up to 4%, up to 2% or up to 1%.

Such maximum permitted strains for the composite material may be significantly larger than a maximum permitted strain for a conventional material such as steel, aluminium or the like. Accordingly, an auxiliary conduit comprising such a composite material may provide a compliant conduit by virtue of the properties of the composite material alone.

Forming the auxiliary conduit from a composite material may assist to minimise the weight of the system, for example relative to all metal riser systems known in the art.

The auxiliary conduit may be radially secured relative to the primary conduit via the connecting portion. That is, relative radial movement of the primary and auxiliary conduits at the connecting portion may be prevented or restricted.

The auxiliary conduit may be axially secured relative to the primary conduit at the connecting portion. That is, relative axial movement of the primary and auxiliary conduits at the connecting portion may be prevented or restricted.

The riser system may be configured such that the auxiliary conduit at least partially supports the weight of the primary conduit. Such an arrangement may generate axial strain within the auxiliary component. However, forming the auxiliary conduit from a composite material may permit increased levels of stress to be accommodated such that said auxiliary conduit may appropriately provide support to the primary conduit. Furthermore, load sharing between the primary and auxiliary conduits may permit the primary conduit to be reduced in size, providing a number of benefits such as weight reduction, cost reduction and the like. Further, in some situations, for example where extremely large pressures and hoop strains must be accommodated, the primary conduit may increased in size, and thus weight, while the auxiliary conduit contributes to supporting this additional weight.

Load sharing between the primary and auxiliary conduits may be achieved via the connecting portion. For example, the auxiliary conduit may be configured to at least partially support the weight of the primary conduit through the connecting portion. In such an arrangement the auxiliary conduit located above the connecting portion may at least partially support the weight of the primary conduit below the connecting portion.

The auxiliary conduit may be pre-tensioned, for example against or relative to the connecting portion. Such pretension may permit the auxiliary conduit to at least partially support the weight of the primary conduit below said connecting portion. Furthermore, such pre-tension may assist to accommodate increased levels of compression within the auxiliary conduit, which may, for example, be present during bending of the riser system.

The riser system may comprise a plurality of connecting portions permitting the auxiliary component to be secured relative to the primary conduit at multiple points along the length of the riser system. One, more than one, or all of the individual connecting portions may define a load transfer point to permit transference of loads between the primary conduit and the auxiliary conduit.

The connecting portion may comprise or be defined by a flanged connection. The connecting portion may comprise a pair of flange components secured together to define a flanged connection.

The riser system may comprise a plurality of auxiliary conduits. The auxiliary conduits may be circumferentially distributed about the primary conduit. Two or more of the plurality of auxiliary conduits may be configured similarly. Two or more of the plurality of auxiliary conduits may be configured differently.

The primary conduit may be of a larger diameter than the auxiliary conduit. The auxiliary conduit may extend externally of the primary conduit. The auxiliary conduit may extend internally of the primary conduit.

The primary conduit may comprise a metal or metal alloy.

The primary conduit may comprise a composite material formed of at least a matrix and one or more reinforcing elements embedded within the matrix. The primary and auxiliary conduits may comprise a similar composite material construction.

The matrix of one or both of the primary and auxiliary conduits may comprise a polymer material. The matrix of one or both of the primary and auxiliary conduits may comprise a thermoplastic material. The matrix of one or both of the primary and auxiliary conduits may comprise a thermoset material. The matrix of one or both of the primary and auxiliary conduits may comprise a polyaryl ether ketone, a polyaryl ketone, a polyether ketone (PEK), a polyether ether ketone (PEEK), a polycarbonate or the like, or any suitable combination thereof. The matrix of one or both of the primary and auxiliary conduits may comprise a polymeric resin, such as an epoxy resin or the like.

The reinforcing elements of one or both of the primary and auxiliary conduits may comprise continuous or elongate elements. The reinforcing elements of one or both of the primary and auxiliary conduits may comprise any one or combination of polymeric fibres, for example aramid fibres, or non-polymeric fibres, for example carbon, glass or basalt elements or the like. The reinforcing elements of one or both of the primary and auxiliary conduits may comprise fibres, strands, filaments, nanotubes or the like. The reinforcing elements of one or both of the primary and auxiliary conduits may comprise discontinuous elements.

The matrix and the reinforcing elements of one or both of the primary and auxiliary conduits may comprise similar or identical materials. For example, the reinforcing elements may comprise the same material as the matrix, albeit in a fibrous, drawn, elongate form or the like.

The connecting portion may be comprise a metal or metal alloy.

The connecting portion may comprise a composite material formed of at least a matrix and one or more reinforcing elements embedded within the matrix. The connecting portion and auxiliary conduit may comprise a similar composite material construction.

The riser system may comprise a continuous auxiliary conduit along the length of the riser system. For example, the auxiliary conduit may be provided as a unitary component. In such an arrangement the auxiliary conduit may be deployed from a spool, directly as it is manufactured, or the like. Where a continuous auxiliary conduit is present said conduit may be clamped relative to the connecting portion.

The riser system may comprise a modular auxiliary conduit. The auxiliary conduit may comprise a plurality of discrete auxiliary conduit sections secured together in end-to-end relation along the length of the riser system. Adjacent discrete auxiliary conduit sections may be secured together via the connecting portion. Adjacent discrete auxiliary conduit sections may be mechanically secured relative to the connecting portion. Adjacent discrete auxiliary conduit sections may be fluidly coupled relative to the connecting portion.

An end region of one discrete auxiliary conduit may directly engage an end region of an adjacent discrete auxiliary conduit at the location of the connecting portion. For example, adjacent discrete auxiliary conduits may extend through or into the connecting portion to be engaged with each other.

End regions of adjacent discrete auxiliary conduits may terminate remotely from each other, for example at separate regions of the connecting portion. In such an arrangement the connection portion may be interposed between respective end regions of adjacent discrete auxiliary conduits. The connecting portion may define an interface conduit portion, for example provided by a bore, sleeve or the like, configured to provide fluid communication between said adjacent discrete auxiliary conduits.

The riser system may comprise a continuous primary conduit along the length of the riser system. For example, the primary conduit may be provided as a unitary component. In such an arrangement the primary conduit may be deployed from a spool, directly as it is manufactured, or the like.

The riser system may comprise a modular primary conduit. The primary conduit may comprise a plurality of discrete primary conduit sections secured together in end-to-end relation along the length of the riser system. Individual discrete primary conduit sections may be secured together via the connecting portion.

The riser system may comprise a plurality of riser joint sections coupled together in end-to-end relation. Each riser joint section may comprise a section of primary conduit and a section of auxiliary conduit coupled together via one or more corresponding connecting portions. In one embodiment each riser joint section may comprise a connecting portion at each end, wherein the associated primary and auxiliary conduit sections extend between the respective connecting portions. Adjacent riser joint sections may be secured together via respective connecting portions.

The connecting portion may be integrally formed with the primary conduit. In an alternative embodiment the connecting portion may be separately formed and subsequently secured to the primary conduit, for example via mechanical fasteners, a stab-in type connector, welding, melding or the like.

The connecting portion may be integrally formed with the auxiliary conduit. In an alternative embodiment the connecting portion may be separately formed and subsequently secured to the auxiliary conduit, for example via mechanical fasteners, a stab-in type connector, welding, melding or the like.

The auxiliary conduit may be secured to the connecting portion via a releasable connector, such as a stab-in type connector, collet-type connector or the like.

The auxiliary conduit may comprise an interface portion configured to mechanically engage the connector portion. The interface portion may facilitate securing of the auxiliary component to the connector via mechanical fasteners, such as bolts or the like. In such an arrangement the interface portion may comprise one or bore holes for receiving one or more mechanical fasteners.

The interface portion may define a thread configured for threaded engagement with the connector portion.

The interface portion may define a profile configured to engage a corresponding profile formed on or within the connector portion. The profiled interface portion may comprise a wedge shaped profile, for example. The profiled interface portion may comprise a region of increased outer diameter relative to the auxiliary conduit portion.

The interface portion may be integrally formed with the auxiliary conduit. Alternatively, the interface portion may be separately formed and subsequently secured to the auxiliary conduit.

The interface portion may comprise a composite material formed of at least a matrix and one or more reinforcing elements embedded within the matrix. The interface portion may be formed integrally with or may comprise an end region of the auxiliary conduit. The interface portion may permit an end face of the auxiliary conduit to extend through the conduit connector portion and engage, for example directly or indirectly, an end face of a further auxiliary conduit

The interface portion may comprise a flange.

At least the auxiliary conduit may comprise a wall comprising the composite material, wherein the wall comprises or defines a local variation in construction to provide a local variation in a property of the auxiliary conduit.

Such a local variation in a property of the auxiliary conduit may permit tailoring of a response of the auxiliary conduit to given load conditions.

The local variation in construction may comprise at least one of a circumferential variation, a radial variation and an axial variation in the riser material and/or the auxiliary conduit geometry.

The local variation in construction may comprise a local variation in the composite material.

The local variation in construction may comprise a variation in the matrix material. The local variation in construction may comprise a variation in a material property of the matrix material such as the strength, stiffness, Young's modulus, density, thermal expansion coefficient, thermal conductivity, or the like.

The local variation in construction may comprise a variation in the reinforcing elements. The local variation in construction may comprise a variation in a material property of the reinforcing elements such as the strength, stiffness, Young's modulus, density, distribution, configuration, orientation, pre-stress, thermal expansion coefficient, thermal conductivity or the like. The local variation in construction may comprise a variation in an alignment angle of the reinforcing elements within the composite material. In such an arrangement the alignment angle of the reinforcing elements may be defined relative to the longitudinal axis of the auxiliary conduit. For example, an element provided at a 0 degree alignment angle will run entirely longitudinally of the auxiliary conduit, and an element provided at a 90 degree alignment angle will run entirely circumferentially of the auxiliary conduit, with elements at intermediate alignment angles running both circumferentially and longitudinally of the auxiliary conduit, for example in a spiral or helical pattern.

The local variation in the alignment angle may include elements having an alignment angle of between, for example, 0 and 90 degrees, between 0 and 45 degrees or between 0 and 20 degrees.

At least one portion of the auxiliary conduit wall may comprise a local variation in reinforcing element pre-stress. In this arrangement the reinforcing element pre-stress may be considered to be a pre-stress, such as a tensile pre-stress and/or compressive pre-stress applied to a reinforcing element during manufacture of the auxiliary conduit, and which pre-stress is at least partially or residually retained within the manufactured auxiliary conduit. A local variation in reinforcing element pre-stress may permit a desired characteristic of the auxiliary conduit to be achieved, such as a desired bending characteristic. This may assist to position or manipulate the auxiliary conduit, for example during installation, retrieval, coiling or the like. Further, this local variation in reinforcing element pre-stress may assist to shift a neutral position of strain within the auxiliary conduit wall, which may assist to provide more level strain distribution when the auxiliary conduit is in use, and/or for example is stored, such as in a coiled configuration.

In embodiments where the primary conduit comprises a composite material, similar constructional variations to those described above in relation to the auxiliary conduit may also apply to the primary conduit.

According to a second aspect of the present invention there is provided a method of forming a riser system to be secured between a surface vessel and a subsea location, comprising:

providing a primary conduit;

extending an auxiliary conduit adjacent the primary conduit, wherein the auxiliary conduit comprises a composite material formed of at least a matrix and one or more reinforcing elements embedded within the matrix; and

connecting the primary and auxiliary conduits together at an axial location along the riser system via a connecting portion.

According to a third aspect of the present invention there is provided a riser system joint for use in forming a riser system, comprising:

a section of primary conduit;

a section of auxiliary conduit extending adjacent the primary conduit and comprising a composite material formed of at least a matrix and one or more reinforcing elements embedded within the matrix; and

at least one connecting portion located at one end of the riser system joint for connecting together the primary and auxiliary conduits.

A connecting portion may be provided at opposite ends of the joint.

At least the auxiliary conduit may be pre-tensioned between the end connecting portions. This arrangement may permit the auxiliary conduit to share loading applied by or through the primary conduit when in use, for example when installed to form part of a riser system.

According to a fourth aspect of the present invention there is provided a conduit system comprising:

a primary conduit; and

an auxiliary conduit extending adjacent the primary conduit and comprising a composite material formed of at least a matrix and one or more reinforcing elements embedded within the matrix,

wherein the primary and auxiliary conduits are connected together at an axial location along the conduit system via a connecting portion.

According to a fifth aspect of the present invention there is provided a riser system configured to be secured between a surface vessel and a subsea location, said system comprising:

a primary conduit; and

an auxiliary conduit extending adjacent the primary conduit and comprising a composite material formed of at least a matrix and one or more reinforcing elements embedded within the matrix.

It should be understood that features presented in accordance with one aspect may be provided in combination with or in accordance with any other aspect.

### BRIEF DESCRIPTION OF THE DRAWINGS

These and other aspects of the present invention will now be described, by way of example only, with reference to the accompanying drawings, in which:

FIG. 1 is a diagrammatic illustration of a drilling riser system in accordance with an aspect of the present invention;

FIG. 2 is an enlarged view of a portion of the drilling riser system of FIG. 1;

FIG. 3 is a lateral cross-sectional view of the drilling riser system taken through line 3-3 in FIG. 2;

FIG. 4 is an enlarged longitudinal cross-sectional view in the region of a connection portion of a riser system in accordance with an embodiment of the present invention;

FIG. 5 is an enlarged view of a portion of a connection portion of a riser system in accordance with an alternative embodiment of the present invention; and

FIG. 6 is an enlarged view of a portion of a connection portion of a riser system in accordance with a further alternative embodiment of the present invention.

### DETAILED DESCRIPTION OF THE DRAWINGS

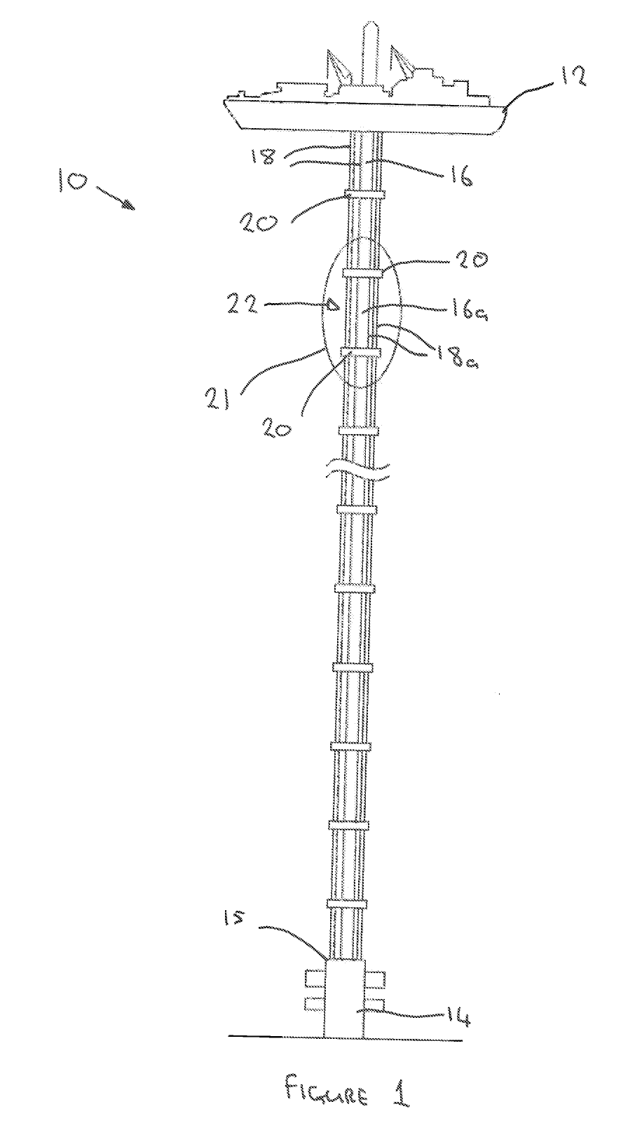

A drilling riser system, generally identified by reference numeral 10, in accordance with an embodiment of the present invention is illustrated in FIG. 1. The riser system 10 extends between a surface vessel 12, which in the present embodiment is a drilling ship, and a subsea wellhead 14 (which may include a BOP 15). The drilling riser system 10 comprises a central large bore primary conduit 16 and a plurality of smaller auxiliary conduits 18 which are circumferentially distributed around the primary conduit 16. The auxiliary conduits 18 are mechanically secured to the primary conduit via a plurality of axially arranged connecting portions 20. In use, the primary conduit 16 accommodates drilling equipment and certain fluids, such as drilling mud and the like, whereas the auxiliary conduits 18 accommodate the communication of other fluids between the surface vessel 12 and the wellhead 14. Such other fluids may include well kill fluids, purge fluids, control fluids for operation of subsea or wellbore equipment, such as the BOP 15 and the like.

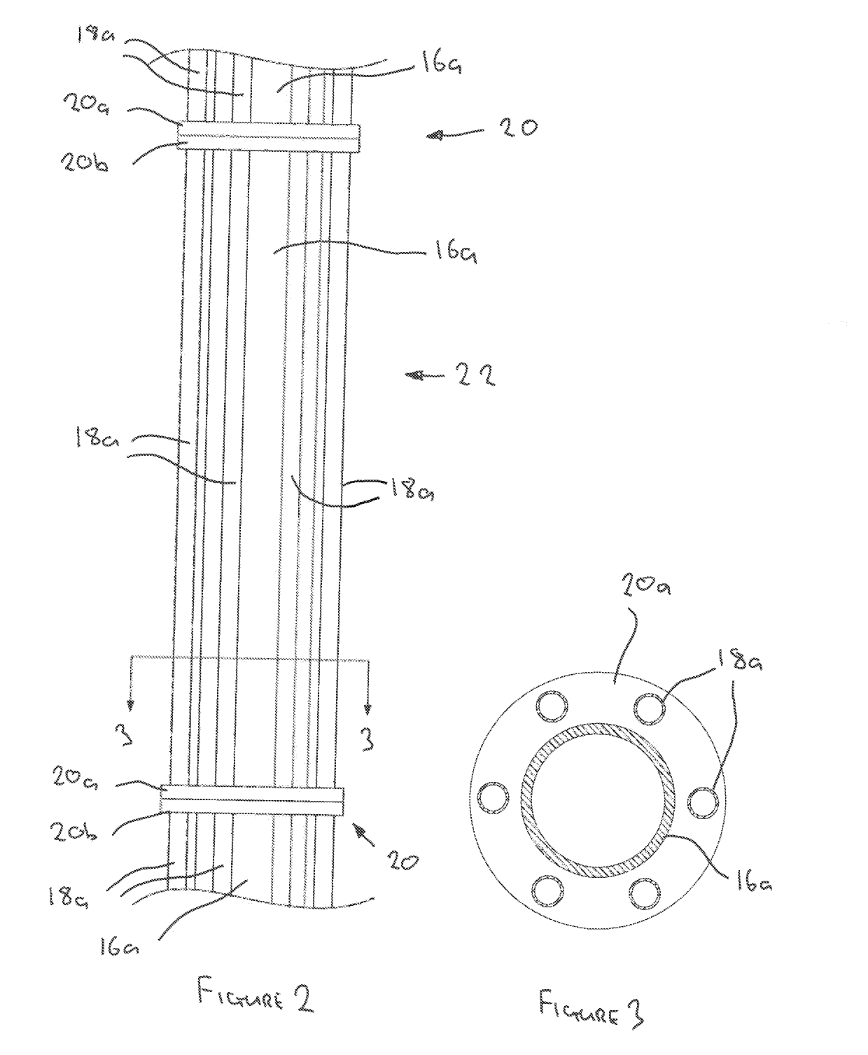

Reference is now additionally made to FIGS. 2 and 3, wherein FIG. 2 is an enlarged view in the region 21 of FIG. 1, and FIG. 3 is a lateral cross-sectional view taken through line 3-3 of FIG. 2.

The riser system 10 is formed from a plurality of individual riser joints 22 which are secured together in end-to-end relation via the connecting portions 20. Each joint 22 includes a discrete primary conduit section 16a and a plurality of discrete auxiliary conduit sections 18a. Opposite ends of each joint 22 include a respective flange component 20a, 20b to which the primary conduit section 18a and auxiliary conduit sections 18a are secured. With particular reference to FIG. 2, the flange components 20a, 20b of adjacent joints 22 are secured together, for example by bolts (not shown) to establish connection between the individual joints 22 at a connecting portion 20. The individual flange components 20a, 20b of each connecting portion 20 established both mechanical and fluid connection between the individual primary and auxiliary conduit sections 16a, 18a.

In the present invention at least one and in some embodiments all of the auxiliary conduits 18 comprise or are formed from a composite material of at least a matrix and one or more reinforcing elements embedded within the matrix. As will be described in detail below, composing the auxiliary conduits 18 of a composite material provides significant advantages over known arrangements, for example in arrangements in which metallic auxiliary lines are utilised. In this respect, the composite material of the auxiliary conduits 18 may be configured to withstand or permit axial and/or bending strains of up to 6%, up to 4%, up to 2% or up to 1%. Such maximum permitted strains for the composite material may be significantly larger than a maximum permitted strain for a conventional material such as steel, aluminium or the like. Accordingly, an auxiliary conduit 18 comprising such a composite material may provide a compliant conduit by virtue of the properties of the composite material alone. This may reduce or eliminate the requirement for additional measures to protect the auxiliary conduits from excessive strains.

During use, the riser system 10 will be subject to various operational loads. For example, the riser system 10 will be subject to bending loads which may be caused by deviation of the vessel 12 from above the wellhead 14. Furthermore, the riser system 10 will be subject to significant tension, primarily generated by its own weight, which in increasing water depths can be significant. Also, increasing water depths will expose the riser system 10 to increasing pressures, such as hydrostatic pressures, which will typically be manifested as hoop strain within the conduits 16, 18 of the riser system 10. The requirement to accommodate such tensile and pressure originating loading may necessitate the use of very thick-walled conduits, which in turn may add significantly to the weight of the entire system. In some cases such design requirements may result in the operational capacity of the vessel 12 being exceeded.

As the auxiliary conduits 18 are secured relative to the primary conduit 18 at the connecting portions 20, deflection or deformation of the primary conduit 16 due to bending will result in load transference to the auxiliary conduits 18 across the connecting portion 20 which will cause corresponding deflection or deformation of the auxiliary conduits 18. During bending, opposing auxiliary conduits 18 may be exposed to different levels of strain; for example one auxiliary conduit may be subject to significant axial tension, whereas an opposing auxiliary conduit may be subject to significant axial compression. The present invention may address such differential strain during load transference between the primary and auxiliary conduits 16, 18 by forming the auxiliary conduit from a composite material. That is, the use of a composite material may permit increased levels of strain to be accommodated such that the auxiliary conduits may be suitably compliant during such periods of deformation, preventing or minimising failure, such as tensile failure, buckling or the like.

Further, differential strain applied to different auxiliary members 18 may place significant loading, particularly bending, on the connecting portions 20. Providing auxiliary conduits 18 composed of composite material may permit a proportionally larger strain being accommodated by the auxiliary conduit 18, thus assisting to protect the connecting portion 20.

Furthermore, forming the auxiliary conduits 18 from a composite material may assist to minimise the weight of the system, for example relative to all metal riser systems known in the art. This may permit thicker-walled conduit sections to be utilised without exceeding weight limits, such as may be dictated by the surface vessel 12.

As described above and illustrated in the drawings, in the exemplary embodiment the primary and auxiliary conduit sections 16a, 18a of a riser joint 22 are secured between respective flange components 20a, 20b. In the present exemplary embodiment one or more of the auxiliary conduit sections 18a are connected to the respective flange components 20a, 20b such that a pretension is applied within the auxiliary conduit section 18a. During use, this pretension permits axial loading to be transferred from the primary conduit section 16a to the auxiliary conduit sections 18a via the flange components 20a, 20b (connecting portion 20). As such, the pretensioned auxiliary conduits 18 may share some of the axial loading within the riser system 10 with the primary conduit 16. That is, pretensioned auxiliary conduits 18 may function to support at least a portion of the weight of the primary conduit 16. Such an arrangement may generate axial strain within the auxiliary conduits 18. However, forming the auxiliary conduits 18 from a composite material will permit increased levels of strain to be accommodated such that said auxiliary conduits 18 may appropriately provide support to the primary conduit 16. Furthermore, load sharing between the primary and auxiliary conduits 16, 18 may permit the primary conduit 16 to be reduced in size, providing a number of benefits such as weight reduction, cost reduction and the like.

Providing a pretension within one or more of the auxiliary conduits 18 may also provide protection to the auxiliary conduit 18 during compression thereof.

In the present embodiment the primary conduit 16 may be formed of a metallic material. However, in other embodiments the primary conduit 10 may be formed of a composite material.

Also, in the present embodiment the connecting portions 20 may be formed of a metallic material. However, in other embodiments at least one of the connecting portions 20 may be formed of a composite material.

There are a number of possible arrangements to provide connection between individual auxiliary conduit sections 18a and a flange portion 20a, 20b or a connecting portion 20. Such arrangements include providing both mechanical and fluid connection.

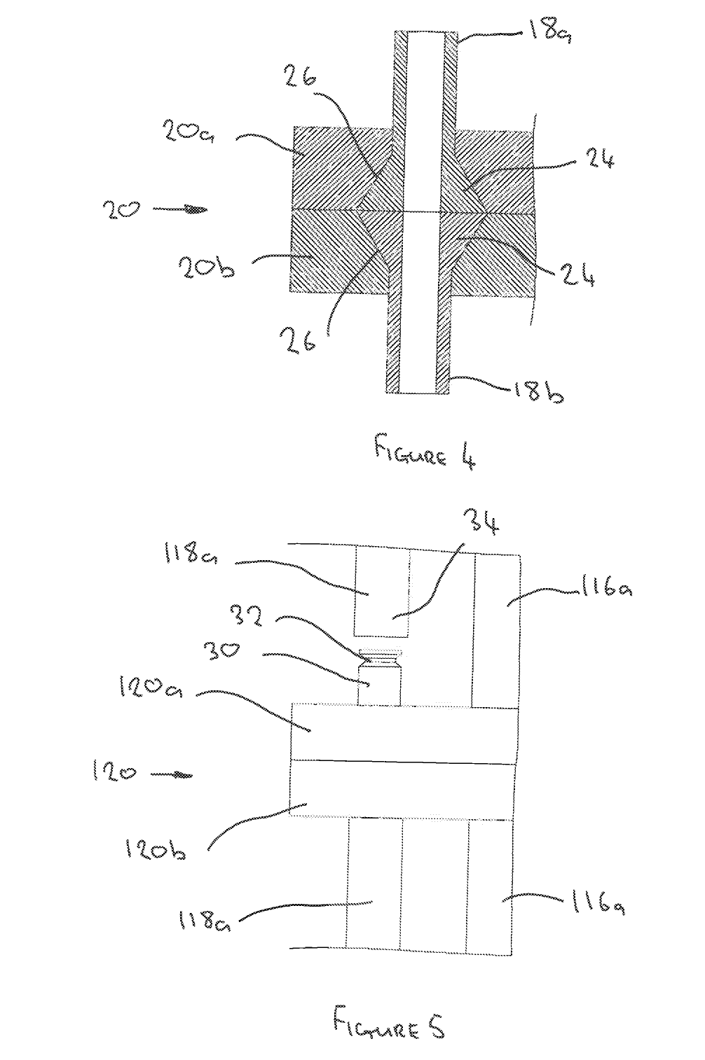

One such exemplary connection arrangement is shown in FIG. 4, which is a cross-sectional view of the riser system 10 in the region of a connecting portion 20. In this embodiment the end region of each auxiliary conduit section 18a extends through a respective flanged component 20a, 20b. Thus, when the individual flange components 20a, 20b are engaged and secured together the ends of adjacent auxiliary conduit sections 18a abut each other. Thus, a continuous conduit may be provided by the connected auxiliary conduit sections 18a through the connecting portions 20. Although not illustrated, a sealing arrangement may be provided between the flange components 20a, 20b and/or the conduit sections 18a. Also, in some embodiments the composite material of the auxiliary conduit sections 18a may permit inherent compliance upon engagement together to provide appropriate sealing.

A wedge or conical profiled portion 24 is defined on the end of each auxiliary conduit section 18a which is received within a corresponding profile 26 formed within the respective flange components 20a, 20b. In the illustrated embodiment the wedge profiled portions 24 are integrally formed with the end of the respective conduits 18a. In this way, an auxiliary conduit section may be robustly secured between end flange components 20a, 20b of a riser joint section 22. Further, this arrangement can permit the auxiliary conduit section 18a to transmit a load, such as a tensile load, between respective flange components 20a, 20b of a riser joint 22.

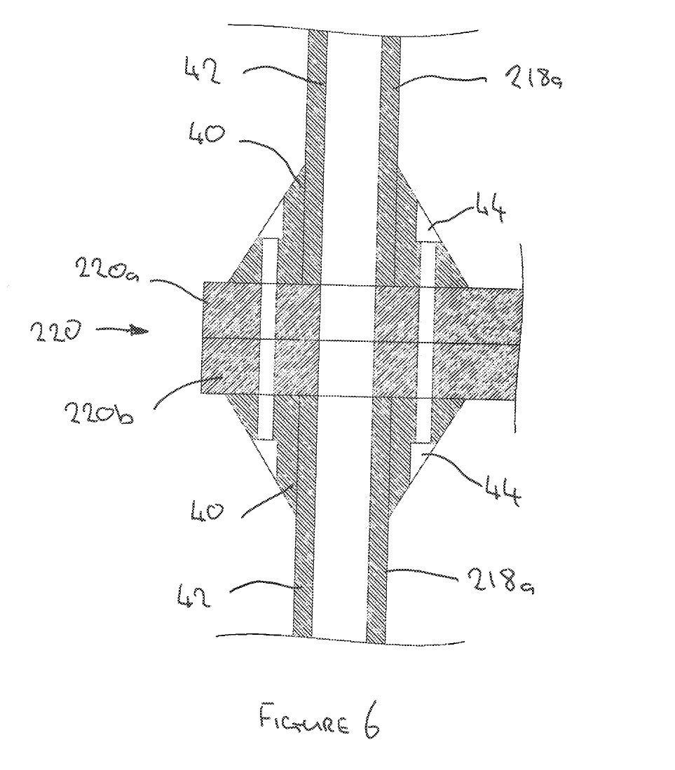

An alternative connection arrangement is shown in FIG. 5, reference to which is now made. In this case the connection arrangement is generally similar to that shown in FIG. 4 and as such like components share like reference numerals, incremented by 100. Thus, a connecting portion 120 is composed of a pair of flange components 120a, 120b which permit primary conduit sections 116a and auxiliary conduit sections 118a to be coupled together. Each flange component 120a, 120b comprises an interface component 30 (the upper auxiliary conduit section 118a is shown disconnected to illustrate the interface component 30). The interface component 30 comprises a quick connect profile 32 which may engage a corresponding profile within the end 34 of the auxiliary conduit section 118a. In this respect the corresponding profile within the auxiliary conduit section 118a may be integrally formed therewith, or alternatively may be provided on a separate component which itself is secured to the end 34 of said conduit section 118a. Furthermore, in the illustrated embodiment the interface component is defined as a male component which is received within a female end 34 of an auxiliary conduit section 118a. However, in other embodiments the interface component may define a female socket configured to receive a male portion formed on the end 34 of the auxiliary conduit section 118a, for example in the form of a stab-in type connector.

In the embodiment shown in FIG. 5, the connected flange components 120a, 120b of the connecting portion 120 may define an internal flow path configured to fluidly couple adjacent (upper and lower) auxiliary conduit sections 118a.

A further alternative embodiment of a connecting arrangement is illustrated in FIG. 6, reference to which is now made. In this case the connection arrangement is generally similar to that shown in FIG. 4 and as such like components share like reference numerals, incremented by 200. Thus, a connecting portion 220 is composed of a pair of flange components 220a, 220b which permit primary conduit sections (not illustrated) and auxiliary conduit sections 218a to be coupled together. The end of each adjacent auxiliary conduit section 218a includes an integrally formed composite connecting profile 40 (the connecting profile could alternatively be a separate component) which permits the end regions 42 of the auxiliary conduit sections 218a to be connected to a respective flange component 220a, 220b. In the illustrated embodiment each connecting profile 40 comprises a number of holes 44 for permitting a bolted connection with an associated flange component 220a, 220b.

It should be understood that the embodiments described herein are merely exemplary and that various modifications may be made thereto. For example, the riser system is not limited for use as a drilling riser system. Furthermore, the principles of the invention need not only be applied to riser systems, and may be utilised within conduit systems which comprise multiple individual conduits running alongside each other.

Furthermore, in the embodiments described above the auxiliary conduits are established by a number of discrete conduit sections joined together at the connecting portions. However, in other embodiments a continuous length of auxiliary conduit may be provided. In such an arrangement the continuous conduit may extend through a connecting portion, for example through a suitably dimensioned throughbore or the like.

1. A riser system configured to be secured between a surface vessel and a subsea location, said system comprising:
a primary conduit; and
an auxiliary conduit extending adjacent the primary conduit and comprising a composite material formed of at least a matrix and one or more reinforcing elements embedded within the matrix,
wherein the primary and auxiliary conduits are connected together at an axial location along the riser system via a connecting portion.

2. The riser system according to claim 1, comprising or defining a drilling riser system.

3. The riser system according to claim 1, wherein the composite material is be configured to withstand or permit axial and/or bending strains of up to 6%, up to 4%, up to 2% or up to 1%.

4. The riser system according to claim 1, wherein the auxiliary conduit is axially secured relative to the primary conduit at the connecting portion.

5. The riser system according to claim 1, wherein the auxiliary conduit at least partially supports the weight of the primary conduit.

6. The riser system according to claim 1, wherein the auxiliary conduit is pre-tensioned against or relative to the connecting portion.

7. The riser system according to claim 1, comprising a continuous auxiliary conduit along the length of the riser system.

8. The riser system according to claim 1, comprising a modular auxiliary conduit. having a plurality of discrete auxiliary conduit sections secured together in end-to-end relation along the length of the riser system.

9. The riser system according to claim 8, wherein adjacent discrete auxiliary conduit sections are secured together via the connecting portion.

10. The riser system according to claim 8, wherein an end region of one discrete auxiliary conduit engages an end region of an adjacent discrete auxiliary conduit at the location of the connecting portion.

11. The riser system according to claim 8, wherein adjacent discrete auxiliary conduits extend through or into the connecting portion to be engaged with each other.

12. The riser system according to claim 8, wherein end regions of adjacent discrete auxiliary conduits terminate remotely from each other.

13. The riser system according to claim 1, comprising a continuous primary conduit along the length of the riser system.

14. The riser system according to claim 1, comprising a modular primary conduit. having a plurality of discrete primary conduit sections secured together in end-to-end relation along the length of the riser system.

15. The riser system according to claim 1, comprising a plurality of riser joint sections coupled together in end-to-end relation.

16. The riser system according to claim 15, wherein each riser joint section comprises a section of primary conduit and a section of auxiliary conduit coupled together via one or more corresponding connecting portions.

17. The riser system according to claim 16, wherein each riser joint section comprises a connecting portion at each end, wherein the associated primary and auxiliary conduit sections extend between the respective connecting portions.

18. The riser system according to claim 1, wherein adjacent riser joint sections are secured together via respective connecting portions.

19. The riser system according to claim 1, wherein the auxiliary conduit is secured to the connecting portion via a releasable connector.

20. The riser system according to claim 1, wherein the auxiliary conduit comprises an interface portion configured to mechanically engage the connector portion.

21. The riser system according to claim 20, wherein the interface portion defines a profile configured to engage a corresponding profile formed on or within the connector portion.

22. The riser system according to claim 1, wherein at least the auxiliary conduit comprises a wall comprising the composite material, wherein the wall comprises or defines a local variation in construction to provide a local variation in a property of the auxiliary conduit.

23. A method for forming a riser system to be secured between a surface vessel and a subsea location, comprising:
providing a primary conduit;
extending an auxiliary conduit adjacent the primary conduit, wherein the auxiliary conduit comprises a composite material formed of at least a matrix and one or more reinforcing elements embedded within the matrix; and
connecting the primary and auxiliary conduits together at an axial location along the riser system via a connecting portion.

24. A riser system joint for use in forming a riser system, comprising:
a section of primary conduit;
a section of auxiliary conduit extending adjacent the primary conduit and comprising a composite material formed of at least a matrix and one or more reinforcing elements embedded within the matrix; and
at least one connecting portion located at one end of the riser system joint for connecting together the primary and auxiliary conduits.

25. The riser system joint according to claim 24, wherein a connecting portion is provided at opposite ends of the joint.

26. The riser system according to claim 25, wherein at least the auxiliary conduit is pre-tensioned between the end connecting portions.
